(19) United States
(12) Patent Application Publication
(10) Pub. No.: US 2016/0059630 A1
(43) Pub. Date: Mar. 3, 2016

(54) TIRE PLY AND METHOD OF MANUFACTURE

(71) Applicant: The Goodyear Tire & Rubber Company, Akron, OH (US)

(72) Inventors: Hongbing Chen, Broadview Heights, OH (US); Gary Robert Burg, Massillon, OH (US); Nathan Andrew Hunt, Akron, OH (US); Christopher David Dyrlund, Canton, OH (US); Patrice De Monte, Arlon (BE)

(21) Appl. No.: 14/751,355

(22) Filed: Jun. 26, 2015

Related U.S. Application Data
(60) Provisional application No. 62/042,947, filed on Aug. 28, 2014.

(51) Int. Cl. B60C 9/04; B29D 30/08

(52) U.S. Cl. CPC B60C 9/04; B29D 30/08; B60C 2009/0425

(57) ABSTRACT

A method of forming a layer of tire ply is disclosed. A first strip of ply is provided having a plurality of evenly spaced reinforcement cords, having a spacing S, and having a lateral end, wherein the last two cords are spaced apart a distance X, wherein X is not equal to S. A second strip of ply is provided having a plurality of evenly spaced reinforcement cords, having a spacing S, and having a lateral end, wherein the last two cords are spaced apart a distance Y, wherein Y is not equal to S. The lateral ends of the first and second strip are joined together in a lap joint. The first and second lateral ends are overlapped so that the spacing X partially or completely overlaps with the spacing Y.

### FIELD OF THE INVENTION

The invention relates to tire ply and method of manufacturing ply.

### BACKGROUND OF THE INVENTION

Tires are typically comprised of one or more layers of ply. The one or more plies are typically applied in a sheet form onto a tire building drum. The sheet of ply is wrapped about the drum, cut to the desired length and then assembled together. The cut ends of each sheet are spliced together. The ends of the ply are typically overlapped as a lap joint, as shown in FIG. 3. This stock is then rolled up and taken to the tire building drum. Once built into a finished tire, the ply in regions B causes a restriction in the ply due to the added strength and stiffness of the overlapped ply cords. Regions A and C typically have excessive spreading between the cords due to their proximity to the restriction in region B. The overlap of ply material can contribute to tire high speed nonuniformity and can also cause visible depressions in the sidewall. It is known in the art to join the ply ends via a butt splice, wherein there is no overlap of material. However, forming a butt splice joint generally requires additional capital equipment in order to form the butt splice. The butt splice is also not as strong or as reliable as the lap slice.

Thus an improved method and apparatus for forming a splice that does not require an additional investment in capital equipment is described.

### SUMMARY OF THE INVENTION

The invention provides a method of forming a layer of tire ply by providing a first strip of ply having a plurality of evenly spaced reinforcement cords with a spacing S, and having a lateral end, wherein two cords at the lateral end are spaced apart a distance X, wherein X is not equal to S; providing a second strip of ply having a plurality of evenly spaced reinforcement cords having a spacing S, and having a lateral end, wherein two cords at the lateral end are spaced apart a distance Y, wherein Y is not equal to S; and joining the first and second lateral ends so that the spacing X partially or completely overlaps with the spacing Y.

### DEFINITIONS

“Aspect Ratio” means the ratio of a tire's section height to its section width.

“Axial” and “axially” means the lines or directions that are parallel to the longitudinal axis of the ply. In reference to the tire, “axial” means lines or direction parallel to the rotational axis of the tire.

“Bead” or “Bead Core” means generally that part of the tire comprising an annular tensile member, the radially inner beads are associated with holding the tire to the rim being wrapped by ply cords and shaped, with or without other reinforcement elements such as flippers, chippers, apexes or fillers, toe guards and chafers.

“Belt Structure” or “Reinforcing Belts” means at least two annular layers or plies of parallel cords, woven or unwoven, underlying the tread, unanchored to the bead, and having both left and right cord angles in the range from 17° to 27° with respect to the equatorial plane of the tire.

“Bias Ply Tire” means that the reinforcing cords in the carcass ply extend diagonally across the tire from bead-to-bead at about 25-65° angle with respect to the equatorial plane of the tire, the ply cords running at opposite angles in alternate layers

“Breakers” or “Tire Breakers” means the same as belt or belt structure or reinforcement belts.

“Carcass” means a laminate of tire ply material and other tire components cut to length suitable for splicing, or already spliced, into a cylindrical or toroidal shape. Additional components may be added to the carcass prior to its being vulcanized to create the molded tire.

“Circumferential” means lines or directions extending along the perimeter of the surface of the annular tread perpendicular to the radial direction, or lines or directions perpendicular to the radial direction;

“Cord” means one of the reinforcement strands, including fibers, which are used to reinforce the plies.

“Inner Liner” means the layer or layers of elastomer or other material that form the inside surface of a tubeless tire and that contain the inflating fluid within the tire.

“Inserts” means the reinforcement typically used to reinforce the sidewalls of runflat-type tires; it also refers to the elastomeric insert that underlies the tread.

“Ply” means a cord-reinforced layer of elastomer-coated, radially deployed or otherwise parallel reinforcement cords.

“Radial” and “radially” mean directions radially toward or away from the axis of rotation of the tire.

“Radial Ply Structure” means the one or more carcass plies or which at least one ply has reinforcing cords oriented at an angle of between 65° and 90° with respect to the equatorial plane of the tire.

“Radial Ply Tire” means a belted or circumferentially-restricted pneumatic tire in which the ply cords which extend from bead to bead are laid at cord angles between 65° and 90° with respect to the equatorial plane of the tire.

“Sidewall” means a portion of a tire between the tread and the bead.

“Lateral” means the outer end of the strip in the direction of the longitudinal axis of the strip.

### BRIEF DESCRIPTION OF THE DRAWINGS

The invention will be described by way of example and with reference to the accompanying drawings in which:

FIG. 1 is a schematic top view of a ply fabric undergoing shearing;

FIG. 2 is a schematic of the cut ply material shown spliced together on a tire drum;

FIG. 3 is a cross-sectional view of a conventional lap splice;

FIG. 4 is a cross-sectional view of a first embodiment of a lap joint formed from two ends of a ply which are joined together;

FIGS. 5A and 5B are cross-sectional views of second and third embodiments of the lap joint;

FIG. 6 is a cross-sectional view of a fourth embodiment of a lap joint formed from two ends of a ply which are joined together;

FIG. 7 is a cross-sectional view of a portion of a tire in the bead area.

### DETAILED DESCRIPTION OF THE INVENTION

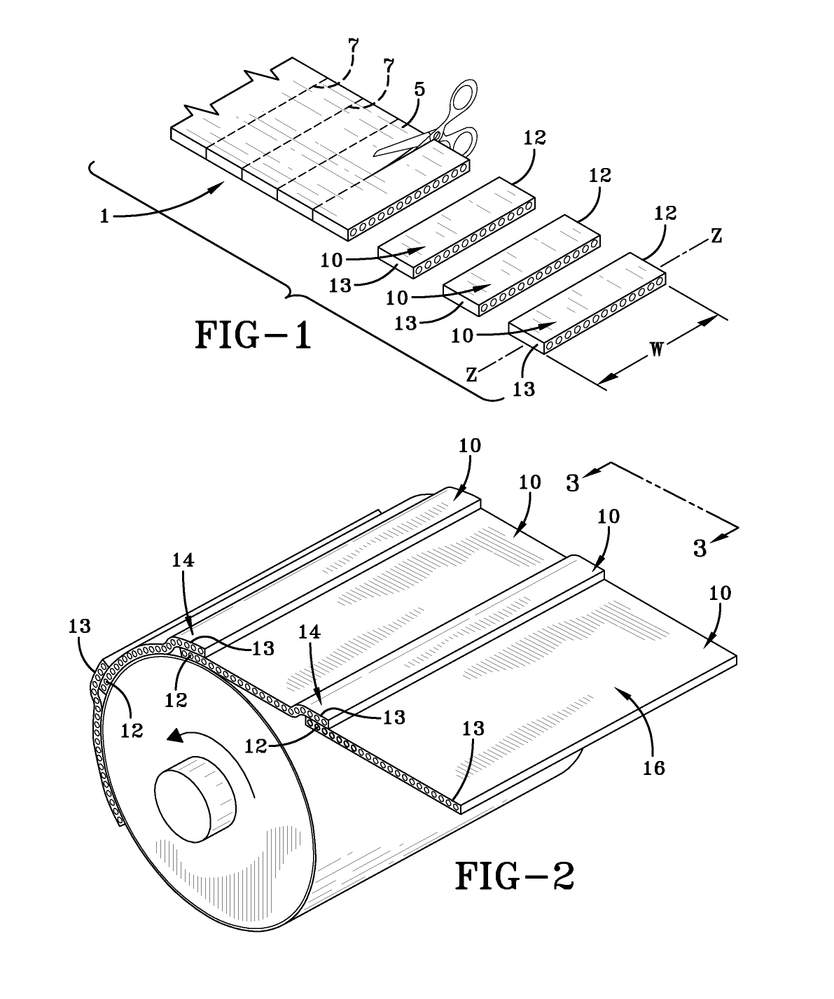

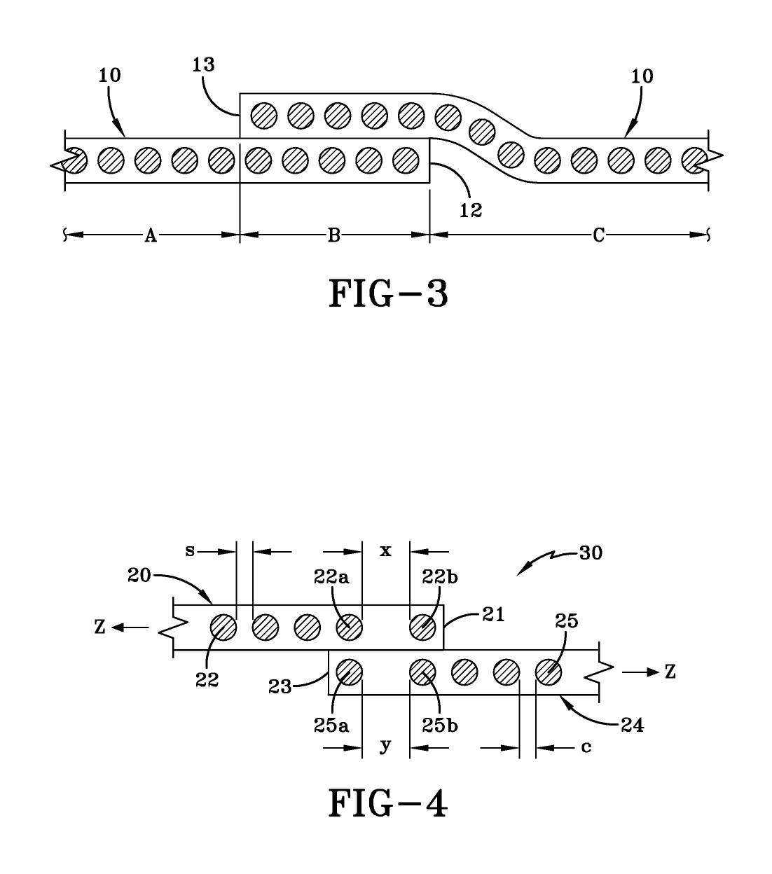

A first embodiment of the present invention is shown in FIG. 4, which illustrates a lap joint 30. The inventive lap joints described herein are useful for joining together ends of reinforcement ply. The lap joint is also useful for joining together ends 21,23 of a first ply strip 20 and a second ply strip 24. The ply strips 20,24 are the same as strips 10 shown in FIG. 1. The ply strips have a defined width W and a defined length L. The reinforcement cords in each strip are in parallel alignment with the longitudinal axis of the strip as shown in FIG. 2. The first ply strips 20,24 are made from the process as shown in FIG. 1, wherein the lateral end 13 of a first strip is joined to the lateral end 12 of a second strip in the form of a lap joint 14, continuing the process to form a sheet of ply 16 as shown in FIG. 2. The lateral ends 12,13 are overlapped, so that the cords of each end are in parallel alignment as shown in FIG. 2. The lap joint 14 may also be used to join together the lateral ends of a sheet of ply.

As shown in FIG. 4, the lateral end 21 of the first ply strip 20 has a plurality of parallel cords 22 arranged transverse to the length of the strip of the material. The cords 22 are in parallel alignment and are evenly spaced apart a distance S throughout the length of the first ply 20, except at the lateral end 21. The ply cords typically have an epi (ends per inch) in the range of 17-35, resulting in a range of S of about 0.001 to about 0.02 inch. At the lateral end, the spacing X between the last two cords is in the range of 1.5*S to 4*S, more preferably 2*S to 3*S, and most preferably 3*S. In the embodiment shown in FIG. 4, the distance X is equal to 2*S+D, wherein D is the cord diameter. The second ply strip 24 has a plurality of parallel aligned cords 25 arranged transverse to the length of the sheet of the material. The cords 25 are evenly spaced apart a distance C through the length of the second ply, except at the lateral end 23. At the lateral end 23, the spacing Y between the last two cords is in the range of 1.5*C to 4*C, more preferably 2*S to 3*S, and most preferably 3*S. In the embodiment shown in FIG. 4, the distance Y is equal to 2*C+D, wherein D is the cord diameter. As shown in FIG. 4, the spacing X is in parallel alignment with the spacing Y. Preferably, the spacing X exactly overlaps with the spacing Y so that the cords 22a,b on either end of the spacing X are in parallel alignment with the cords 23a,23b on either end of the spacing Y. More preferably, X equals Y. In the spacing X and Y, there is no cord present, and there is no partial cord/broken cord present.

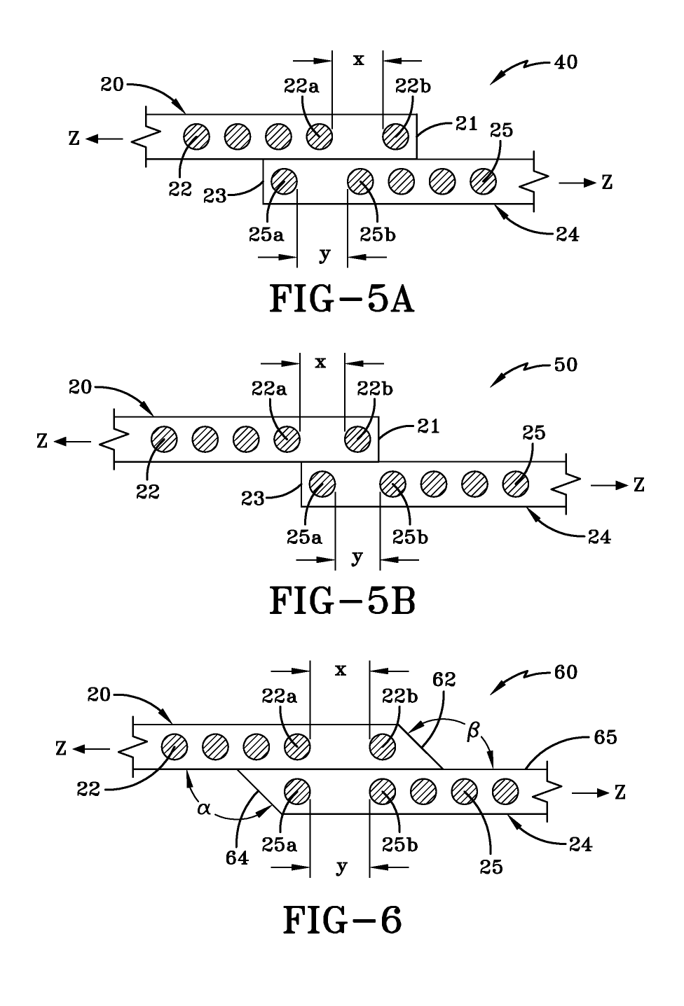

FIG. 5A illustrates a second embodiment 40 of a ply lap joint. The lap joint 40 is formed so that there is a slight overlap of the X and Y spacing in the transverse direction, but the cords 22a, 23a and cords 22b, 23b are not aligned in the transverse direction. Reinforcement cord 23b is located between reinforcement cords 22a,22b of the strip 20. Reinforcement cord 23b is located opposite the X spacing, and reinforcement cord 22a is located opposite the Y spacing.

FIG. 5B illustrates a third embodiment 50 with a slight overlap of the X and Y spacing in the transverse direction. The cords 22a, 23a and cords 22b, 23b are not aligned in the transverse direction. The X spacing is located adjacent the cord 23a, and the Y spacing is located adjacent the cord 22b. In this embodiment, due to the location of the X and Y spacing, there is no double layer of cords in the lap joint.

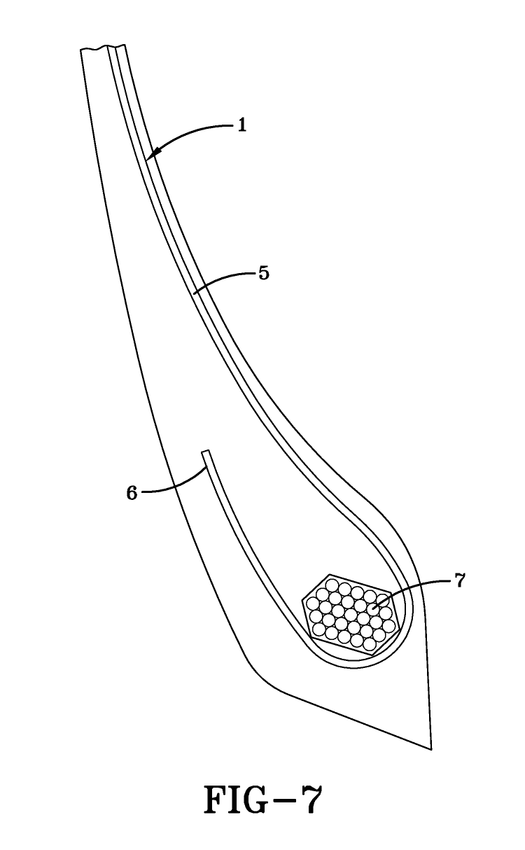

FIG. 6 illustrates a fourth embodiment 60 which is the same as the embodiment of FIG. 4, with the following differences In this embodiment, the ply ends 62,64 are angled. An angle beta is formed between the angled ply end 62 with the transverse direction. The angle beta is greater than 90 degrees but less than 180 degrees. An angle gamma is formed between the angled ply end 64 with the transverse direction. The angle gamma is greater than 90 degrees but less than 180 degrees. The embodiments of FIGS. 5A and 5B may also be combined with the fourth embodiment so that the ply ends 21,23 are angled.

The resulting lap joints described above have the strength of the prior art lap joint but without the disadvantage of the overlap of two functional cords.

FIG. 7 illustrates a tire that has a layer of ply 5 wrapped around a bead 7. The ply is formed from a plurality of ply strips lap spliced together as shown in FIGS. 1-2 formed with a lap joints of any of the inventions described herein. The reinforcement cords are oriented in the radial direction of the tire. When the lap joint of FIG. 4 is used, cords 22a, 23a and 22b,23b align in a transverse direction (perpendicular to the radial direction). The spacing X and spacing Y likewise align in the transverse direction, perpendicular to the radial direction.

Variations in the present invention are possible in light of the description of it provided herein. While certain representative embodiments and details have been shown for the purpose of illustrating the subject invention, it will be apparent to those skilled in this art that various changes and modifications can be made therein without departing from the scope of the subject invention. It is, therefore, to be understood that changes can be made in the particular embodiments described which will be within the full intended scope of the invention as defined by the following appended claims. cm What is claimed is:

1. A method of forming a layer of tire ply comprising the following steps:
a. providing a first strip of ply having a plurality of evenly spaced reinforcement cords with a spacing S, and having a lateral end, wherein two cords at the lateral end are not evenly spaced, and said two cords are spaced apart a distance X, wherein X is not equal to S;
b. providing a second strip of ply having a plurality of evenly spaced reinforcement cords having a spacing S, and having a lateral end wherein two cords at the lateral end are not evenly spaced, wherein said two cords at the lateral end are spaced apart a distance Y, wherein Y is not equal to S;
c. joining the first and second lateral ends so that the spacing X partially overlaps with the spacing Y.

2. The method of claim 1 wherein Y is greater than S.

3. The method of claim 1 wherein X is greater than S.

4. The method of claim 1 wherein Y is greater than 2*S.

5. The method of claim 1 wherein X is greater than 2*S.

6. The method of claim 1 wherein X equals Y.

7. The method of claim 1 wherein the two cords of the first strip of ply are the last two cords on the end of the first strip.

8. The method of claim 1 wherein the two cords of the second strip of ply are the last two cords on the end of the second strip.

9. The method of claim 1 wherein the cords of the first strip lateral end are in parallel alignment with the cords of the second strip lateral end.

10. The method of claim 1 wherein the cords of the first strip lateral end are not in alignment with the cords of the second strip lateral end.

11. The method of claim 1 wherein a cord of the first strip lateral end is located between the last two cords of the second strip lateral end.

12. The method of claim 1 wherein the last cord of the first strip lateral end is located between the last two cords of the second strip lateral end.

13. The method of claim 1 wherein the last cord of the first strip lateral end is located adjacent the spacing Y of the second strip lateral end.

14. The method of claim 1 wherein the spacing X between the last two cords is in the range of 1.5*S to 4*S.

15. The method of claim 1 wherein the spacing X between the last two cords is in the range of 2*S to 3.5*S.

16. The method of claim 1 wherein the spacing X between the last two cords is in the range of 2.5*S to 3*S.

17. The method of claim 1 wherein the spacing X between the last two cords is equal to 2*S+D, wherein D is the cord diameter, and S is the cord spacing.

18. The method of claim 1 wherein the spacing Y between the last two cords is equal to 2*C+D, wherein D is the cord diameter, and C is the cord spacing.

19. The method of claim 1 wherein the spacing X between the last two cords is greater than 2*S+D, wherein D is the cord diameter, and S is the cord spacing.

20. The method of claim 1 wherein the spacing Y between the last two cords is greater than 2*C+D, wherein D is the cord diameter, and C is the cord spacing.

21. A method of forming a layer of tire ply comprising the following steps:
a. providing a first strip of ply having a plurality of evenly spaced reinforcement cords with a spacing S, and having a lateral end, wherein the last two cords at the lateral end are spaced apart a distance X, wherein X is not equal to S;
b. providing a second strip of ply having a plurality of evenly spaced reinforcement cords having a spacing S, and having a lateral end, wherein the last two cords at the lateral end are spaced apart a distance Y, wherein Y is not equal to S;
c. joining the first and second lateral ends so that the spacing X completely overlaps with the spacing Y so that they are in a parallel relationship.

22. The method of claim 12 wherein the cords of the first strip lateral end are in alignment with the cords of the second strip lateral end.

23. A pneumatic radial tire comprising: a carcass ply wound around each of a pair of bead cores, wherein the carcass ply is formed from a first strip of ply and a second strip of ply, wherein the first strip of ply has a plurality of evenly spaced reinforcement cords with a spacing S, and having a lateral end, wherein the last two cords at the lateral end are spaced apart a distance X, wherein X is not equal to S; wherein the second strip of ply has a plurality of evenly spaced reinforcement cords having a spacing S, and having a lateral end, wherein the last two cords at the lateral end are spaced apart a distance Y, wherein Y is not equal to S; wherein the first and second lateral ends are joined together in a lap joint wherein the spacing X partially overlaps with the spacing Y.

24. The pneumatic radial tire of claim 21 wherein the cords of the first strip's lateral end are in parallel alignment with the cords of the second strip lateral end.

25. The pneumatic radial tire of claim 21 wherein the cords of the first strip lateral end are not in alignment with the cords of the second strip lateral end.

26. The pneumatic radial tire of claim 21 wherein a cord of the first strip lateral end is located between the last two cords of the second strip lateral end.

27. The pneumatic radial tire of claim 21 wherein the last cord of the first strip lateral end is located between the last two cords of the second strip lateral end.

28. The pneumatic radial tire of claim 21 wherein the last cord of the first strip lateral end is located adjacent the spacing Y of the second strip lateral end.

29. The pneumatic radial tire of claim 21 wherein the spacing X between the last two cords is in the range of 1.5*S to 4*S.

30. The pneumatic radial tire of claim 21 wherein the spacing X between the last two cords is equal to 2*S+D, wherein D is the cord diameter, and S is the cord spacing.

31. The pneumatic radial tire of claim 1 wherein the spacing Y between the last two cords is equal to 2*C+D, wherein D is the cord diameter, and C is the cord spacing.

32. The pneumatic radial tire of claim 21 wherein the spacing X between the last two cords is greater than 2*S+D, wherein D is the cord diameter, and S is the cord spacing.

33. The pneumatic radial tire of claim 21 wherein the spacing Y between the last two cords is greater than 2*C+D, wherein D is the cord diameter, and C is the cord spacing.
